(19) United States
(12) Patent Application Publication
(10) Pub. No.: US 2026/0281212 A1
(43) Pub. Date: Sep. 17, 2026

(54) Aggregated Communication Via Multiple Communication Protocols

(71) Applicant: Shure Acquisition Holdings, Inc., Niles, IL (US)

(72) Inventors: Benjamin John Daniel, Elk Grove Village, IL (US); Cameron Christopher Ketchmark, Chicago, IL (US); Ryan John Flores, Chicago, IL (US); Mark Rollin Pauna, Woodbridge, IL (US); Mike Handler, Munster, IN (US); Steven John Van Gheem, Gilberts, IL (US)

(21) Appl. No.: 19/179,399

(22) Filed: Apr. 15, 2025

Related U.S. Application Data
(60) Provisional application No. 63/641,600, filed on May 2, 2024.

(51) Int. Cl. H04L 69/18; H04W 28/02; H04W 28/06; H04W 88/10

(52) U.S. Cl. CPC H04L 69/18; H04W 28/0273; H04W 28/06; H04W 88/10

(57) ABSTRACT

Aspects of the disclosure relate to use of multiple communication protocols in a communication network. The use of multiple communication protocols may be facilitated by a wireless hub comprising a distributor/aggregator module to coordinate signal transmissions and receptions. Messaging may utilize an indexing feature that may prevent retransmission of data via multiple communication protocols based on receiving an acknowledgment via one of the multiple communication protocols. Further, channel utilization may additionally be reduced by the use of a prefetch module which may predetermine information that may be requested in the communication network and request such information, from other devices, for future delivery.

### CROSS-REFERENCE TO RELATED APPLICATION

This application claims the benefit of U.S. Provisional Patent Application No. 63/641,600, filed on May 2, 2024, which is fully incorporated herein by reference.

### TECHNICAL FIELD

Aspects of the disclosure relate to wireless communication and more specifically to communication networks utilizing multiple communication protocols.

### BACKGROUND

A communication device may communicate with one or more other devices using a communication protocol (e.g., Bluetooth, Zigbee, Wi-Fi, etc.). A specific protocol to be utilized by the device may be based on a status of a communication channel, capabilities of the other devices, a user preference, etc. Devices may exchange protocol-specific control messages to establish a communication channel for communicating via a specific protocol.

### SUMMARY

Aspects of the disclosure provide effective, scalable, and reliable technical solutions that address and overcome the problems associated with simultaneous use of multiple communication protocols.

An example communication system may comprise a wireless hub, one or more access points (APs), and/or one or more wireless devices. Communications within the communication system may utilize multiple communication protocols. For example, the wireless hub may send a message (e.g., multiple copies of a message) to a wireless device using multiple communication protocols. Each copy of the message may comprise a same index value which may help a receiving device to coordinate receptions via the multiple communication protocols. For example, the wireless device may use the index values to determine whether a message (e.g., received via a first communication protocol) needs to be processed, or is a copy of a previously received message (e.g., received via a second communication protocol). Successful reception of a message may be indicated by an acknowledgment message which may comprise a same index value as that of the message. A wireless hub, receiving the acknowledgment message, may cease any further transmissions of the message via any of the multiple communication protocols.

The wireless hub may comprise components for enhancing communication efficiency. For example, the wireless hub may comprise one or more of: a compression module, a property cache, and/or a prefetch module. The compression module may aggregate multiple pieces of information (e.g., property values associated with devices in the communication system) in a single message which may reduce signaling overhead. The property cache may store property values for retrieval as and when required. The prefetch module may predict, retrieve, and/or store property values that may be required in the future by one or more devices/applications associated with the communication system. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example communication system using a plurality of communication protocols.

FIG. 2 shows an example architecture of a wireless hub in a communication network.

FIG. 3 shows an example method for transmission of a message.

FIG. 4A shows an example method for receiving a message.

FIG. 4B shows an example method for sending a message.

FIG. 5 shows an example method for receiving a message.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Communication between devices may be based on one or more mutually decipherable protocols that may be used to process transmitted and received messages. A protocol may define/codify operation of one or more layers in an Open Systems Interconnection (OSI) model that enable interconnection between and interoperability of multiple devices, applications, and/or systems forming a communication network.

Devices may be capable of processing and communicating messages via one or more communication protocols. Devices may establish a communication session via a specific communication protocol, and maintain communications via that protocol for the duration of the communication session. If the communication channel used for communication via the established session degrades (e.g., exhibits higher noise, higher interference, reduced signal strength, etc.), a communication link between the devices may fail until a new session is established (e.g., using a different channel and/or using a different communication protocol). Such a link failure may cause time delay resulting from control signaling required to establish the new session, additional signaling overhead (e.g., for retransmission of prior messages), etc. As such, inefficiencies may be present even in devices that may be capable of communication via multiple communication protocols. Additional processing may be required to enable these communication channels to contribute to reliability and efficiency.

Various examples herein describe leveraging availability of multiple communication protocols to improve reliability and/or efficiency of communications in a network. A distribution and aggregation mechanism may be added to a communication protocol stack to enable parallel transmission and/or reception of a message (e.g., comprising same/similar data) via multiple communication protocols. An indexing mechanism may be used for messages for coordination across the multiple protocols. For example, indexing may be used to determine whether a message transmission via a specific communication protocol has been successful. The use of indexing may avoid retransmission of successfully transmitted messages (e.g., successfully transmitted messages via a first communication protocol) via any of the plurality of communication protocols used for parallel transmission of the messages. Indexing may also be used at a receiver device to determine whether a received message is a duplicate of a previously received message. A property cache may be utilized to store frequently requested property values and/or reduce utilization of channel resources for transmission/reception of the property values. Further, a prefetching module of a device may be used to predict property values, of other devices, that may be requested by an application associated with the device, and request those property values from the other devices. In this manner, parallel communication facilitated by multiple protocols may be enhanced to improve communication reliability, signaling efficiency, and/or reduced channel overhead.

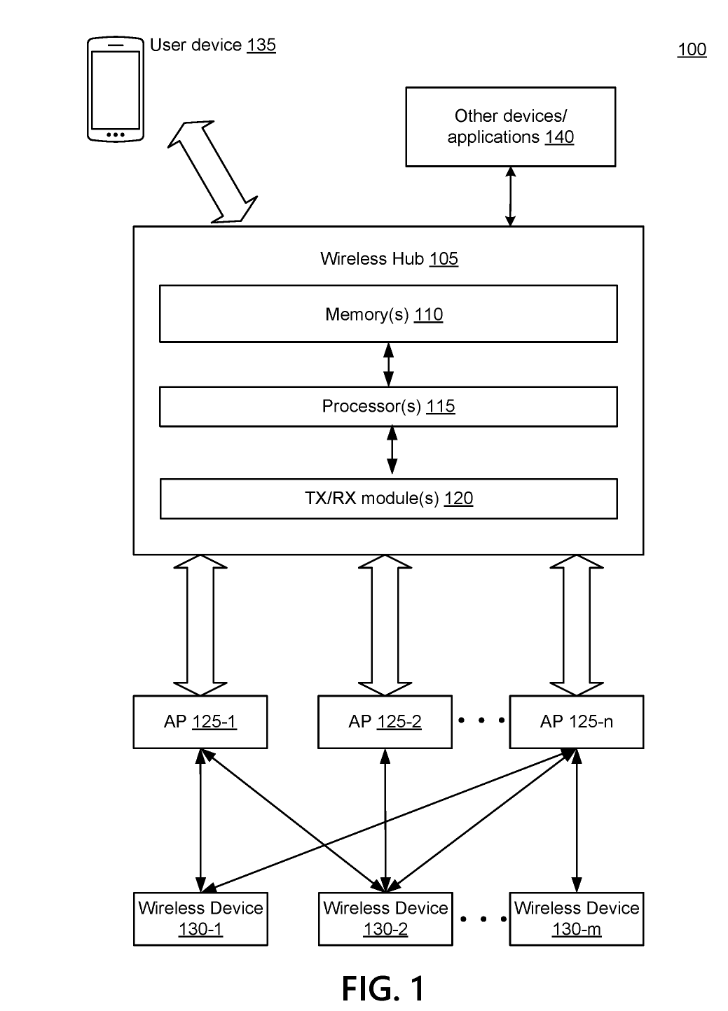

FIG. 1 shows an example communication system 100 using a plurality of communication protocols. The communication system 100 may comprise a wireless hub 105, one or more access points (APs) 125, one or more wireless devices 130, a user device 135, and/or other devices/applications 140. In an example, the communication system may comprise a wireless hub 105 that may communicate with the APs 125-1….125-n and/or the wireless devices 130-1….130-m, where m, n ≥ 1. While the various examples provided herein generally relate to communication between multiple wireless devices, in some examples, one or more devices in the communication system may be wired and/or may use wired communication protocols for communicating with one or more other devices in the communication system.

The wireless hub 105 may comprise one or more of processor(s) 115, transmit/receive (TX/RX) module(s) 120, and/or memory 110. One or more data buses may interconnect the processor(s) 115, the TX/RX module(s) 120, and/or the memory 110. The wireless hub 105 may be implemented using one or more integrated circuits (ICs), software, or a combination thereof, configured to operate as described herein. The memory 110 may comprise any memory such as a random-access memory (RAM), a read-only memory (ROM), a flash memory, or any other electronically readable memory, or the like. The processors 115, TX/RX module(s) 120, and/or other component/modules of the wireless hub 105 may be configured to execute machine readable instructions stored in the memory 110 to perform the various operations described herein. The TX/RX module(s) 120 may comprise mixers, amplifiers, drivers, antennas etc., for wireless transmission and/or reception of signals by the wireless hub 105. Architecture of the APs 125 and/or the wireless devices 130 may be similar to the wireless hub 105. For example, the APs 125 or the wireless devices 130 may each comprise corresponding memory, one or more processor(s), and/or TX/RX modules.

Signals transmitted from and/or received by the wireless hub 105 may be encoded in one or more data units. For example, the processor(s) 115 may be configured to generate data units for transmission, and process received data units, that conform to any suitable wired and/or wireless communication protocol. In an example, the processor(s) 115 may implement functionalities associated with one or more layers of an OSI model, representing the operations of the wireless hub 105, in accordance with one or more communication protocols.

Communications between the devices in the communication system 100 may be via any proprietary and/or non-proprietary communication standards. For example, the TX/RX module 120 may be configured to send/receive signals that are processed using one or more communication protocols corresponding to one or more layers in the OSI model (e.g., Bluetooth protocol(s), Institution of Electrical and Electronics Engineers (IEEE) 802.11 Wi-Fi protocol(s), 3^{rd} Generation Partnership Project (3GPP) cellular protocol(s), local area network (LAN) protocol(s), hypertext transfer protocols (HTTP), side-channel communication protocol(s), and/or any other communication protocol(s)). In examples where the wireless hub 105 is additionally capable of using wired communication protocols, the TX/RX module 120 may be additionally configured to send/receive signals that are processed using one or more wired communication protocols (e.g., universal serial bus (USB) protocol(s), Ethernet protocol(s), and/or any other wired communication protocol). In other examples, and without departing from the scope of this disclosure, a hub and/or an AP of the communication system 100 may solely use one or more wired communication protocols to communicate with one or more other devices in the communication system 100.

In an example, the communication between the devices in the communication system 100 may be via wireless channels that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.). Additionally, or alternatively, the communication between the devices in the communication system 100 may be via (e.g., one or more channels within) a very high frequency (VHF) band (e.g., 30 MHz-300 MHz band) and/or via (e.g., one or more channels within) an ultra-high frequency (UHF) band (e.g., 300 MHz-3 GHz).

The wireless hub 105 may communicate with one or more APs 125 and/or wireless devices 130. The wireless hub 105 may communicate with the wireless devices 130 via one or more APs 105. For example, the wireless hub 105 may send messages to an AP 125-1 and the AP 125-1 may forward the message to one or more wireless devices 130. A wireless device 130 may send messages to the AP 125-2 and the AP 125-2 may forward the message to the wireless hub 105. In this scenario, the APs 105 may function as gatekeepers (e.g., performing device access and control signaling functionalities) of any communications between the wireless hub 105 and the wireless devices 130.

The APs 125 may relay communications between the wireless devices 130 and the wireless hub 105. Each of the APs 125 and/or the wireless devices 130 may be configured to communicate via one or more corresponding communication protocols. For example, the wireless device 130-1 may be capable of using Bluetooth protocol(s) and IEEE 802.11 Wi-Fi protocol(s) for communication. The wireless device 130-2 may be capable of using Bluetooth protocol(s), a Zigbee protocol(s), and an IEEE 802.11 Wi-Fi protocol(s) for communication. The wireless device 130-m may be capable of using an IEEE 802.11 Wi-Fi protocol(s) for communication. The AP 125-1 may be capable of using Bluetooth protocol(s) for communication, the AP 125-2 may be capable of using Zigbee protocol(s) for communication, and the AP 125-n may be capable of using IEEE 802.11 Wi-Fi protocol(s) for communication. Accordingly, the AP 125-1 may transmit/receive Bluetooth signals to/from the wireless devices 130-1 and 130-2. The AP 125-2 may transmit/receive Zigbee signals to/from the wireless device 130-2. The AP 125-3 may transmit/receive IEEE 802.11 Wi-Fi signals to/from the wireless devices 130-1, 130-2, and 130-3. One or more other devices and/or APs may communicate via 3GPP cellular protocol(s), LAN protocol(s), HTTP, side-channel communication protocol(s), USB protocol(s), Ethernet protocol(s), and/or any other wired or wireless communication protocol.

Communications between an AP 125 and the wireless hub 105 may use a same communication protocol as that used for communication between the AP 125 and a connected wireless device 130. For example, the AP 125-1 may use Bluetooth protocol(s) to communicate with the wireless hub 105, the AP 125-2 may use Zigbee protocol(s) to communicate with the wireless hub 105, and the AP 125-3 may use IEEE 802.11 Wi-Fi protocol(s) to communicate with the wireless hub 105.

In other examples, each of the APs 125 may use a common communication protocol (e.g., a backhaul protocol) to communicate with the wireless hub 105. For example, the AP 125-1 may receive data via Bluetooth protocol(s) from the wireless device 130-1, and send the data via the backhaul protocol to the wireless hub 105. The AP 125-2 may receive data via Zigbee protocol(s) from the wireless device 130-2, and send the data via the backhaul protocol to the wireless hub 105. The backhaul protocol may be a Bluetooth protocol, an IEEE 802.11 Wi-Fi protocol, a 3GPP cellular protocol, a LAN protocol, an HTTP, a USB protocol, an Ethernet protocol, and/or any other wired or wireless communication protocol. The backhaul protocol may be same as or different from communication protocol(s) used for communications between the APs 125 and the wireless devices 130.

Additionally or alternatively, the wireless devices 130 may directly communicate with the wireless hub 105 via one or more communication protocols. In such an example, the functionalities and architecture of the AP 125 may be integrated with that of the wireless hub 105.

In one or more examples, the wireless hub 105 may also communicate with one or more user devices 135 (e.g., smartphones, tablet computers, remote control devices, etc.) that may be configured to control operation of the communication system 100. For example, a user device 135 may be used to provide various settings and/or parameters associated with the operation of the wireless hub 105. For example, a user interface, associated with the user device 135, may be used to select APs 125 and/or wireless devices 130 with which the wireless hub 105 may establish communication.

Inputs to the wireless hub 105 may be any audio, video, electrical, and/or electromagnetic signals (e.g., originated from any input devices and/or sources) that may be processed by the wireless hub 105. Outputs from the wireless hub may be any audio, video, electrical, and/or electromagnetic signals that may be played back via output devices, stored in a memory device, and/or processed by other devices.

Wireless devices 130 may comprise one or more input devices and/or output devices. Input devices that may provide input to the wireless hub 105 may comprise one or more of: a microphone, a transceiver associated with a musical instrument, a bodypack transmitter, an audio mixer, a computing device (e.g., smartphone, tablet, laptop, personal computer), a keyboard, mouse, touchscreen, camera, sensor, and/or any other type of input device. Output devices that may be connected to the wireless hub 105, and receive output from the wireless hub 105, may comprise one or more of: a speaker, a wireless headset, an in-ear monitoring (IEM) system, a bodypack receiver, a transceiver associated with a musical instrument, a receiver device with an output interface (e.g., an XLR connector, USB connector, 3.5 mm connector, etc.), a computing device (e.g., smartphone, tablet, laptop, personal computer), an electronic video screen, a printer, a projector, a sound card, a video card, and/or any other type of output device. The wireless devices 130 may comprise one or more electronically-readable memory devices comprising stored audio, video, and/or other data. The memory devices may include random access memory (RAM), read only memory (ROM), electronically erasable programmable read only memory (EEPROM), flash memory or other memory technology, compact disc (CD) ROM, digital versatile disks (DVD) or other optical disk storage, magnetic cassettes, magnetic tape, magnetic disk storage or other magnetic storage devices, or any other medium that can be used to store desired information that can be accessed/processed by wireless hub 105.

In one or more examples, the wireless hub 105 may also communicate with one or more devices and/or applications 140. For example, the wireless hub 105 may receive transmissions from the one or more APs 125 and/or the one or more wireless devices 130, process the transmissions (e.g., via the processors 115), and send the processed transmissions to the devices and/or applications 140. Additionally, the wireless hub 105 may receive transmissions from the devices and/or applications 140, process the transmissions (e.g., via the processors 115), and send the processed transmissions to the one or more APs 125 and/or the one or more wireless devices 130. The one or more devices/applications 140 may comprise audio and/or video processing applications, networking devices/application (e.g., for communicating via internet), a server associated with a computing network (e.g., a local network, public network such as the Internet), etc.

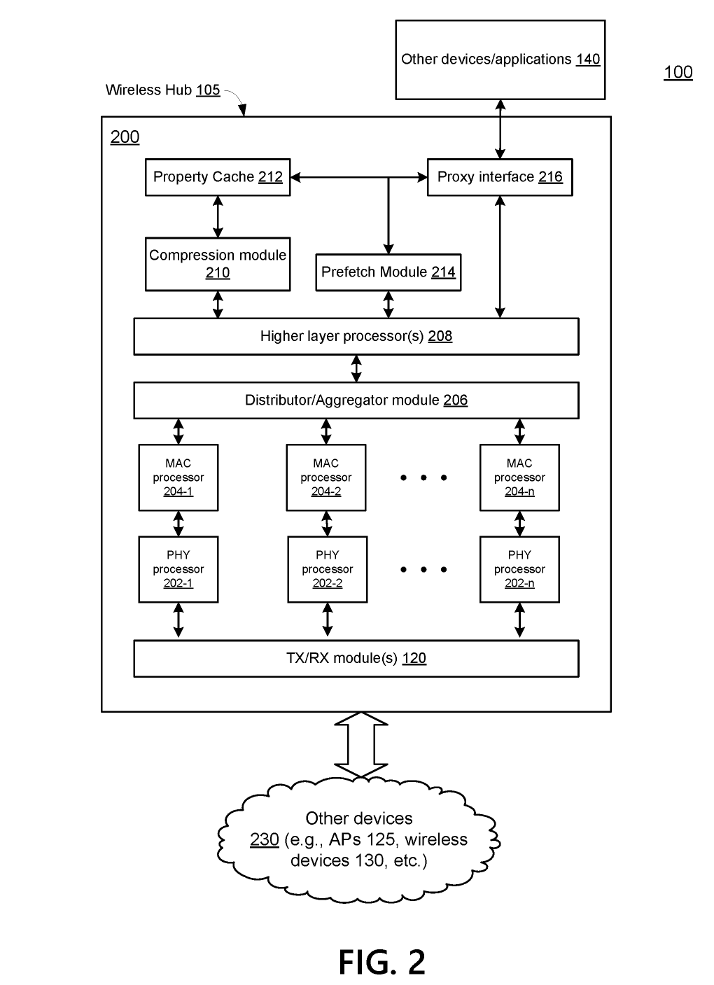

FIG. 2 shows an example architecture 200 of a wireless hub 105 in the communication system 100, such as described with respect to FIG. 1. The wireless hub 105 may comprise multiple processors (e.g., one or more of physical layer (PHY) processor(s) 202, medium access control (MAC) processor(s) 204, higher layer processor(s) 208), a distributor/aggregator module 206, a compression module 210, a property cache 212, a prefetch module 214, and/or a proxy interface 216. Further, and as described with respect to FIG. 1, the wireless hub 105 may additionally or alternatively comprise TX/RX module(s) 120, memory 110, and/or the like. One or more data buses may interconnect the various components of the wireless hub 105. The wireless hub 105 may communicate, via one or more communication protocols, with one or more other devices 230 (e.g., APs 125, wireless devices 130).

The wireless hub 105 may be implemented using one or more integrated circuits (ICs), software, or a combination thereof, configured to operate as discussed below. The various processors (e.g., one or more of physical layer (PHY) processor(s) 202, medium access control (MAC) processor(s) 204, higher layer processor(s) 208) may be implemented, at least partially, on a single IC or multiple ICs.

The APs 125 and/or the wireless devices 130 may comprise one or more modules as described with respect to the architecture 200. For example, the APs 125 and/or the wireless devices 130 may comprise corresponding multiple PHY/MAC layer processors, higher layer processor(s), distributor/aggregator modules, compression modules, property caches, prefetch modules, and/or proxy interfaces, operating in a manner as described with respect to the wireless hub 105.

Messages transmitted from and received by devices in the computing system 100 may be encoded in one or more MAC data units and/or PHY data units. The MAC processor(s) 204 and/or the PHY processor(s) 202 of the wireless hub 105 may be configured to generate data units, and process received data units, that conform to any suitable wired and/or wireless communication protocol. For example, the MAC processor(s) 204 may be configured to implement MAC layer functions, and the PHY processor(s) 202 may be configured to implement PHY layer functions corresponding to a communication protocol. The MAC processor(s) 204 may, for example, generate MAC data units (e.g., MAC protocol data units (MPDUs)), and forward the MAC data units to the PHY processor(s) 202. The PHY processor(s) 202 may, for example, generate PHY data units (e.g., PHY protocol data units (PPDUs)) based on the MAC data units. The generated PHY data units may be transmitted via the TX/RX module(s) 120 to one or more other devices 230. Similarly, the PHY processor(s) 202 may receive PHY data units (e.g., as sent by one or more other devices 230) via the TX/RX module(s) 120, extract MAC data units encapsulated within the PHY data units, and forward the extracted MAC data units to the MAC processor(s) 204. The MAC processor(s) 204 may then process the MAC data units as forwarded by the PHY processor(s) 202.

A MAC processor 204 and an associated PHY processor 202 may operate as a pair to send/receive transmissions corresponding to an associated communication protocol. For example, the MAC processor 204-1 and the PHY processor 202-1 may be used to communicate via Bluetooth protocol(s), the MAC processor 204-2 and the PHY processor 202-2 may be used to communicate via Zigbee protocol(s), and the MAC processor 204-n and the PHY processor 202-n may be used to communicate via IEEE 802.11 Wi-Fi protocol(s). Similarly, one or more other MAC processor(s) 204 and associated PHY processor(s) 202 may be used for communication via 3GPP cellular protocol(s), LAN protocol(s), HTTP, side-channel communication protocol(s), USB protocol(s), Ethernet protocol(s) and/or any other wired or wireless communication protocol. The specific type and/or quantity of communication protocols described herein with reference to FIG. 2 are merely exemplary, and the wireless hub 105 may communicate using any other type and/or quantity of communication protocols.

The distributor/aggregator module 206 may operate above the MAC layer 204 (e.g., as seen from an OSI model perspective). The distributor/aggregator module 206 may operate a corresponding function for parallel communication, via one or more communication protocols, with a corresponding end-point wireless device 130 that is communicating with the wireless hub 105. Each function may communicate via one or more pairs of MAC processor(s) 204 and associated PHY processor(s) 202 with a corresponding wireless device 130. For example, with reference to the example arrangement described with respect to FIG. 1, the distributor/aggregator module 206 may operate a first function to communicate with the wireless device 130-1. The distributor/aggregator module 206 may operate a second function to communicate with the wireless device 130-2. The distributor/aggregator module 206 may operate a third function to communicate with the wireless device 130-m. The first function may perform communications, with the wireless device 130-1, via the MAC processor 204-1 and the PHY processor 202-1 (e.g., using the Bluetooth protocol(s)) and via the MAC processor 204-n and the PHY processor 202-n (e.g., using the IEEE 802.11 Wi-Fi protocol(s)). The second function may perform communications, with the wireless device 130-2, via the MAC processor 204-1 and the PHY processor 202-1 (e.g., using the Bluetooth protocol(s)), via the MAC processor 204-2 and the PHY processor 202-2 (e.g., using the Zigbee protocol(s)), and via the MAC processor 204-n and the PHY processor 202-n (e.g., using the IEEE 802.11 Wi-Fi protocol(s)). The third function may perform communications, with the wireless device 130-m, via the MAC processor 204-n and the PHY processor 202-n (e.g., using the IEEE 802.11 Wi-Fi protocol(s)). Similarly. the distributor/aggregator module 206 may operate one or more other functions to perform communications, via 3GPP cellular protocol(s), LAN protocol(s), HTTP(s), side-channel communication protocol(s), USB protocol(s), Ethernet protocol(s), and/or any other wired or wireless communication protocol, with one or more corresponding devices (e.g., wireless devices 130, or other wired devices). In other words, each pair of a MAC processor 204 and an associated PHY processor 202 may use an associated communication protocol to communicate with corresponding one or more APs 125 and/or wireless devices 130 using that communication protocol.

While the examples described herein are related to communications involving the wireless hub 105, in other scenarios, the devices 130 may only communicate with the APs 125 (e.g., without involving the wireless hub 105). In such an example, the APs 125 may directly communicate with the user devices 135 and/or the other devices/applications 140 (e.g., in a similar manner as described with reference to communications between the wireless hub 105, user devices 135 and/or the other devices/applications 140). Different device identifiers may be used, for an end-point wireless device 130, for an aggregated connection (e.g., using multiple communication protocols) with the wireless hub 105 and for a standalone connection with an AP 125 (e.g., using a single communication protocol) that does not use the wireless hub 105). The use of different device identifiers may avoid the scenario where a same device identifier is associated with two different internet protocol (IP) addresses (e.g., one for communication via an AP 125 without the use of the wireless hub 105, and one for communication via the wireless hub 105).

For signal transmission to a wireless device 130, an associated function of the distributor/aggregator module 206 may duplicate signals for transmission to the wireless device 130 (e.g., via one or more communication protocols that are compatible with the wireless device 130). For example, for transmission of a message to the wireless device 130-1, the first function may cause generation and transmission of two copies of the message (e.g., using Bluetooth protocol and an IEEE 802.11 Wi-Fi protocol compatible with the wireless device 130-1). A first copy of the message may be generated/sent via the MAC processor 204-1 and the PHY processor 202-1 (e.g., using the Bluetooth protocol) and a second copy of the message may be generated/sent via the MAC processor 204-n and the PHY processor 202-n (e.g., using the IEEE 802.11 Wi-Fi protocol). For transmission of a message to the wireless device 130-2, the second function may cause generation and transmission of three copies of the message (e.g., using a Bluetooth protocol, a Zigbee protocol, and an IEEE 802.11 Wi-Fi protocol compatible with the wireless device 130-2). A first copy of the message may be generated/sent via the MAC processor 204-1 and the PHY processor 202-1 (e.g., using the Bluetooth protocol), a second copy of the message may be generated/sent via the MAC processor 204-2 and the PHY processor 202-2 (e.g., using the Zigbee protocol), and a third copy of the message may be sent via the MAC processor 204-n and the PHY processor 202-n (e.g., using the IEEE 802.11 Wi-Fi protocol). The third function may cause generation and transmission of a message to the wireless device 130-m (e.g., using an IEEE 802.11 Wi-Fi protocol). The message may be generated/sent via the MAC processor 204-n and the PHY processor 202-n. One or more other functions may be used for generation and transmission of copies of message to one or more other devices (e.g., wireless devices 130, wired devices) via a 3GPP cellular protocol, a LAN protocol, an HTTP, a side-channel communication protocol, a USB protocol, an Ethernet protocol, and/or any other wired or wireless communication protocol. A message may be transmitted via an AP 125 that is associated with a communication protocol corresponding to the message.

For signal reception from a wireless device 130, an associated function of the distributor/aggregator module 206 may aggregate a plurality of messages or all messages (e.g., as received via one or more communication protocols) from the wireless device 130 for further processing by the wireless hub. For example, the first function may aggregate communications/messages, received from the wireless device 130-1, via the MAC processor 204-1 and the PHY processor 202-1 (e.g., using the Bluetooth protocol(s)) and via the MAC processor 204-n and the PHY processor 202-n (e.g., using the IEEE 802.11 Wi-Fi protocol(s)). The second function may aggregate communications/messages, received from the wireless device 130-2, via the MAC processor 204-1 and the PHY processor 202-1 (e.g., using the Bluetooth protocol(s)), via the MAC processor 204-2 and the PHY processor 202-2 (e.g., using the Zigbee protocol(s)), and via the MAC processor 204-n and the PHY processor 202-n (e.g., using the IEEE 802.11 Wi-Fi protocol(s)). The third function may aggregate communications/messages, received from the wireless device 130-m, via the MAC processor 204-n and the PHY processor 202-n (e.g., using the IEEE 802.11 Wi-Fi protocol(s)). One or more other functions may be used for aggregating communications/messages from one or more other devices (e.g., wireless devices 130, wired devices) received via a 3GPP cellular protocol, a LAN protocol, an HTTP, a side-channel communication protocol, a USB protocol, an Ethernet protocol, and/or any other wired or wireless communication protocol. A message may be received via an AP 125 that is associated with a communication protocol corresponding to the message.

The higher layer processor(s) 208 may implement one or more other layers of the OSI model (e.g., network layer, transport layer, session layer, presentation layer, and/or application layer) representing the operations of the wireless hub 105. The higher layer processor(s) may process data units for transmission via the MAC processor(s) 204 and the PHY processor(s) 202, and process data units as received via the PHY processor(s) 202 and the MAC processor(s) 204.

The compression module 210 may be used to process compact data formats for transmission and/or reception from a wireless device 130. In an example, multiple property values (e.g., control indicators, device identifiers, other control signaling parameters) may be generated for transmission to a wireless device 130. To reduce transmission overhead, the compression module 210 may group together the property values in a single message for transmission (e.g., with a common header). The compression module 210 may also process a received message (e.g., as received from a wireless device 130) to generate multiple property values that may be packaged in the received message.

The property cache 212 may comprise a memory that may be allocated for storage of frequently requested property values associated with the devices in the communication system 100. For example, certain property values associated with one or more devices in the communication system 100 (e.g., APs 125 and/or wireless devices 130) may be frequently requested by other devices (e.g., other APs 125, other wireless devices 130). Example property values include user-provided device names, RF power levels, audio gain levels, audio sensitivity levels, wireless frequencies associated with wireless devices 130, battery status indicators/information (e.g., battery levels, battery cycle count, battery capacity, maximum battery capacity, and battery temperature, etc.), etc. The wireless hub 105 may query (e.g., send request messages to) the one or more devices to determine the frequently requested property values. The one or more devices, based on receiving the request messages, may send the requested property values to the wireless hub 105. The wireless hub 105 may store the received property values in the property cache 212. When a device sends a request for a property value associated with a second device, the wireless hub 105 may query the property cache 212 to determine whether the property value has already been cached. If present in the property cache, the wireless hub 105 may send the requested property value to the device. This may prevent the wireless hub 105 from requiring to send a request for the property value to the second device, thereby reducing communication latency and signaling overhead. The wireless hub 105 may determine whether a property value should be cached in the property cache 212 based on a frequency of requests for the property value.

One or more of the wireless devices 130, the APs 125, and/or the other devices/applications 140 may request property values from one or more devices in the communication system 100 (e.g., from other APs 125 and/or wireless devices 130). Multiple and/or frequent requests for the property values may result increased usage of wireless resource (e.g., frequency and/or time resources), which may reduce the bandwidth available for other communications. The prefetch module 214 may determine (e.g., predict ahead of time) which property values may be requested by a device/application.

Prediction of a property value that may be requested by a device/application may be based on properties that were previously requested by the device/application. For example, the prefetch module 214 may determine that a device may request an indication of an audio sensitivity level based on determining that the device has previously requested an indication of an audio gain level. As another example, the prefetch module 214 may determine that a device may request an indication of firmware status (e.g., an indication of whether the firmware is valid or invalid) and an indication of a device model based on determining that the device has previously requested an indication of a firmware version number. As another example, the prefetch module 214 may determine that a device may request additional battery status information (e.g., battery cycle count, battery capacity, maximum battery capacity, and battery temperature, etc.) based on determining that the device has previously requested an indication of the battery health.

Based on the determination/prediction of property values, the prefetch module 214 may query (e.g., send request messages to) one or more devices to determine one or more property values. The one or more devices, based on receiving the request messages, may send the requested property values to the wireless hub 105. The wireless hub 105 may store the received property values in the property cache 212. The wireless hub 105 may provide (e.g., send and/or indicate) a property value as requested (e.g., by an application/device) by querying the property cache.

The proxy interface 216 may correspond to an interface between the wireless hub 105 and the other devices/applications 140. For example, an application may use the proxy interface 216 to communicate with one or more wireless devices 130 (e.g., via the wireless hub 105 and/or the APs 125). The proxy interface 216 may correspond to a pipeline between a software process associated with the wireless hub 105 (e.g., an application layer of the wireless hub 105) and another application (e.g., operating on another computing device). In an example scenario, the wireless devices 130 may correspond to audio input devices (e.g., microphones) and/or audio output devices (e.g., speaker), and the application may correspond to an audio processing application. The proxy interface 216 may provide a pipeline to send information, as received from the audio input devices, to the audio processing application and/or to receive information, as sent by the audio processing application, for transmission to the audio output devices.

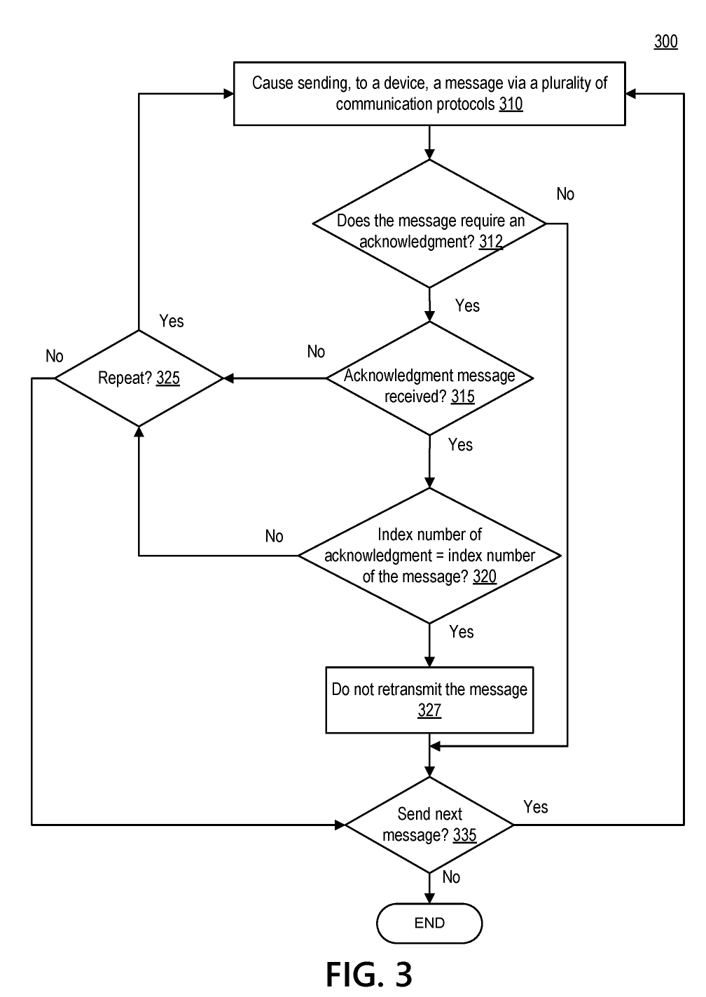

FIG. 3 shows an example method 300 for transmission of a message. The example method 300 may be performed by the wireless hub 105, the APs 125, the wireless devices 130, and/or any other device associated with the communication system 100.

At step 310, a communication device (e.g., the wireless hub 105, an AP 125, a wireless device 130, and/or any other device associated with the communication system 100) may cause sending of a message, to a second communication device, via a plurality communication protocols. Sending a message via a plurality of communication protocols may comprise sending multiple copies of a same message via the plurality of communication protocols (e.g., simultaneously, substantially simultaneously, or in different time periods/transmission opportunities). Each copy of the message as sent to the wireless device 130 may comprise a same index number (e.g., identifier, indicator) that may be used to track whether or not a message has been received via at least one communication protocol of the plurality of communication protocols used for sending the message. The message may be a control message or a data message.

For example, the wireless hub 105 may cause sending of a message to the wireless device 130-2 via a plurality of communication protocols (e.g., Bluetooth protocol(s), Zigbee protocol(s), and IEEE 802.11 Wi-Fi protocol (s)). The wireless hub 105 may send, to the AP 125-1, a first copy of the message via the MAC processor 204-1 and the PHY processor 202-1 (e.g., using the Bluetooth protocol(s)). The wireless hub 105 may send, to the AP 125-2, a second copy of the message via the MAC processor 204-2 and the PHY processor 202-2 (e.g., using the Zigbee protocol(s)). The wireless hub 105 may send, to the AP 125-n, a third copy of the message via the MAC processor 204-n and the PHY processor 202-n (e.g., using the IEEE 802.11 Wi-Fi protocol(s)). In another example, the wireless hub 105 may use one or more backhaul communication protocols (e.g., wired or wireless communication protocols) to send copies of the message to the APs 125. The backhaul communication protocols may be same as or different from the communication protocols used for communications between the APs 125 and the wireless devices 130. The AP 125-1 may send the first copy of the message to the wireless device 130-2 (e.g., using the Bluetooth protocol(s)), the AP 125-2 may send the second copy of the message to the wireless device 130-2 (e.g., using the Zigbee protocol(s)), and the AP 125-n may send the third copy of the message to the wireless device 130-2 (e.g., using the IEEE 802.11 Wi-Fi protocol(s)).

In another example, the wireless hub 105 may send copies of the message to the wireless device 130-2 (e.g., without the use of separate APs 125). The wireless hub 105 may send, to the wireless device 130-2, a first copy of the message via the MAC processor 204-1 and the PHY processor 202-1 (e.g., using the Bluetooth protocol(s)). The wireless hub 105 may send, to the wireless device 130-2, a second copy of the message via the MAC processor 204-2 and the PHY processor 202-2 (e.g., using the Zigbee protocol(s)). The wireless hub 105 may send, to the wireless device 130-2, a third copy of the message via the MAC processor 204-n and the PHY processor 202-n (e.g., using the IEEE 802.11 Wi-Fi protocol(s)). In this scenario, the TX/RX modules 120 of the wireless hub 105 may directly transmit to the wireless device 130-2.

At step 312, the communication device may determine whether the message requires an acknowledgment feedback. For example, certain types of messages comprising “metered” data (e.g., data indicating current audio levels, signal strength levels, battery levels, etc.) may not require an acknowledgment feedback. As another example, a message may be sent by the communication device via a first communication protocol that does not require an acknowledgment feedback and also via a second communication protocol that does require an acknowledgment feedback. If the communication device determines that the message does not require an acknowledgment feedback, the communication device may proceed to step 335. At step 335, the communication device may determine whether to send a next message.

At step 315, and if the message requires an acknowledgment feedback, the communication device may determine whether the acknowledgment message has been received from the second communication device. For example, the communication device may determine whether the acknowledgment message has been received, from the second communication device, via at least one communication protocol of the plurality of communication protocols used for sending the message. If an acknowledgment is not received (e.g., within a predetermined time period following the message transmission), the communication device may determine whether to repeat transmission of the message via the plurality of communication protocols (e.g., step 325). At step 325, and if the communication device determines to repeat transmission of the message, the process may move to step 310. For example, the communication device may perform (e.g., repeat) one or more of steps 310, 312, 315, and/or 320. At step 325, and if the communication device determines to not repeat transmission of the message, the process may move to step 335.

The communication device may receive, from the second communication device, at least one acknowledgment message (e.g., within a predetermined time period following the message transmission) via at least one communication protocol of the plurality of communication protocols used for sending the message. For the example scenario of the wireless hub 105 sending (or causing sending) the message to the wireless device 130-2 via a Bluetooth protocol, a Zigbee protocol, and an IEEE 802.11 Wi-Fi protocol, the wireless hub 105 may receive at least one acknowledgment message via at least one of the Bluetooth protocol, the Zigbee protocol, and the IEEE 802.11 Wi-Fi protocol. For example, the wireless hub 105 may receive, from the AP 125-n and/or from the wireless device 130-2, an acknowledgment message via the IEEE 802.11 Wi-Fi protocol. The wireless hub 105 may receive the acknowledgment message via the MAC processor 204-n and the PHY processor 202-n.

The at least one acknowledgment message may comprise an associated index number. At step 320, and if an acknowledgment message is received, the communication device may compare an index number in the acknowledgment message with the index number of the sent message (e.g., as sent in step 310). If the index number of the acknowledgment message is different from the index number of the sent message, the communication device may determine whether to repeat transmission of the message (e.g., step 325). Repeating transmission of the message may comprise sending the message again to the wireless device 130-2 via the plurality of communication protocols (e.g., as described with respect to step 310).

Determining, at step 325, whether to repeat transmission of the message may comprise determining whether a maximum number of retransmissions for the message has been exceeded. In an example where a maximum number of retransmissions for the message has been exceeded, the communication device may determine to not repeat the message transmission. At step 335, and if the communication device determines to not repeat the message transmission, the communication device may determine whether to send a next message. Determining whether to send a next message may comprise determining whether a next message is present in a buffer. If the next message is present in the buffer, the communication device may cause sending the message (e.g., as described at step 310). If the next message is not present in the buffer, the communication device may stop the method 300.

Determining to repeat transmission of the message may comprise determining whether a message with higher priority is available for transmission (e.g., in a buffer). In an example where a higher priority message is available, the communication device may determine to not repeat the message transmission. At step 335, and if the communication device determines that the higher priority message is available, the communication device may determine to send the higher priority message (e.g., step 335). The communication device may cause sending the higher priority message (e.g., as described at step 310).

If the index number of the acknowledgment message is the same as the index number of the sent message, the communication device may stop further transmissions of the message (e.g., step 327) via all of the plurality of communication protocols. In other words, reception of the acknowledgment message (e.g., with the same index number as the sent message), via at least one of the plurality of communication protocols, may result in ceasing further transmissions of the same message via all of the plurality of communication protocols. At step 335, the communication device may determine whether to send a next message. Determining whether to send a next message may comprise determining whether a next message is present in the buffer. If the next message is not present in the buffer, the communication device may stop the method 300. If the next message is present in the buffer, the communication device may cause sending the message (e.g., as described at step 310). For example, the communication device may transmit the next message via the plurality of communication protocols (e.g., in a manner as described with respect to step 310). Acknowledgment of reception of a message, via a communication protocol, may result in the communication device stopping further transmissions (e.g., transmission repetitions) of the same message via other communication protocols (e.g., that the communication device is using to parallelly communicate with the second communication device). Confirmation of reception of a message (e.g., via the acknowledgment message) at the second communication device via a first communication protocol may be relayed/indicated (e.g., by the distributor/aggregator module 206) to device functions handling communications via other communication protocols, allowing further transmissions (e.g., repeated transmissions) of the same message to the second communication device to be ceased.

Use of multiple communication protocols for transmission of a same message may improve reliability of communications. For example, the multiple communication protocols may provide more opportunities for the communication device to send a message to the second communication which may beneficial in crowded communication environments comprising a large quantity of communication devices.

The use of multiple communication protocols may help in environments with high channel noise levels in specific bandwidths. For example, a wireless channel associated with a first communication protocol may be noisy and may prevent proper reception/decoding of a message at a receiving device via the first communication protocol. However, the second communication device may still may be able to receive the message via a second communication protocol (e.g., which may operate in a wireless channel with lower noise levels). Further, the coordination between the first communication protocol and the second communication protocol (e.g., as facilitated by the distributor/aggregator module 206 and message indexing) may ensure that the communication device may refrain from transmitting a repetition of the message via the first communication protocol, even though message transmission via the first communication protocol had previously failed. Avoiding retransmission of messages in such scenarios may improve transmission efficiency and avoid unnecessary retransmissions of messages that have already been successfully transmitted/received.

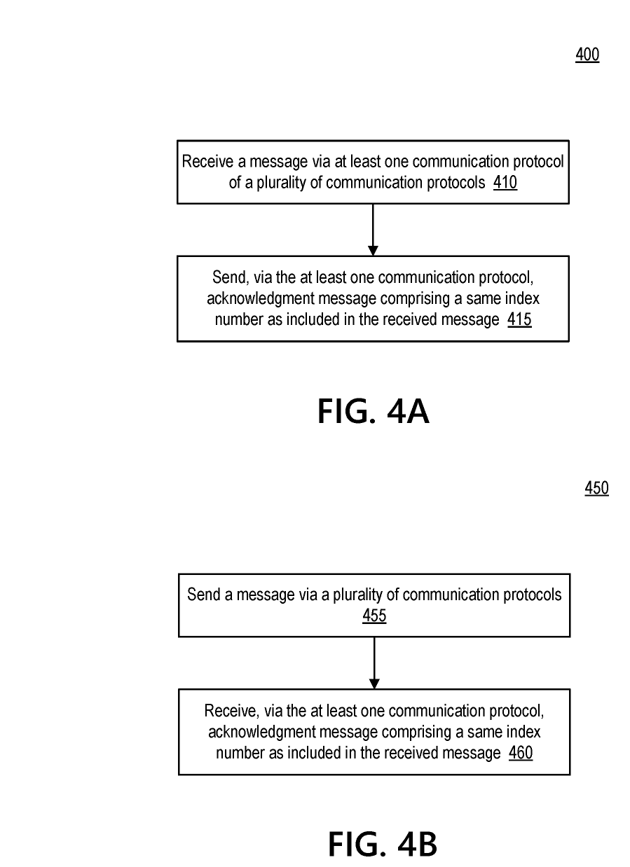

FIG. 4A shows an example method 400 for receiving a message. The example method 400 may be performed by the wireless hub 105, the APs 125, the wireless devices 130, and/or any other device associated with the communication system 100.

At step 410, a first communication device (e.g., the wireless hub 105, an AP 125, a wireless device 130, and/or any other device associated with the communication system 100) may receive a message, from a second communication device, via at least one communication protocol of a plurality of communication protocols. For example, the second communication device may use (or may cause usage of) a plurality of communication protocols to transmit multiple copies of a same message to the first communication device. The first communication device may receive a copy of the message via at least one communication protocol of the plurality of communication protocols. The message may comprise an associated index number (e.g., as described with reference to FIG. 3). In an example, the first communication device may be a wireless device 130 and the second communication device may be the wireless hub 105.

At step 415, the first communication device may send, via the at least one communication protocol, respective acknowledgment message(s) (e.g., confirming successful reception/decoding of the message). For example, the first communication device may send an acknowledgment message, via a communication protocol, if required (e.g., indicated) by the message and/or if the communication protocol requires acknowledgment message transmission.

The acknowledgement message may comprise a same index number as included in the message. In an example scenario wherein the first communication device receives the message via at least two communication protocols of the plurality of communication protocols, the first communication device may send acknowledgment messages via each of the at least two communication protocols. Alternatively, the first communication device may send an acknowledgment message via a selected communication protocol of the at least two communication protocol. The selected communication protocol may correspond to a communication protocol utilizing fewer channel resources and/or having a higher channel availability. Sending an acknowledgment message via only one communication protocol (e.g., even if the message has been successfully received via two or more communication protocols) may reduce signaling overhead.

FIG. 4B shows an example method 450 for receiving a message. The example method 450 may be performed by the wireless hub 105, the APs 125, the wireless devices 130, and/or any other device associated with the communication system 100.

At step 455, a first communication device (e.g., the wireless hub 105, an AP 125, a wireless device 130, and/or any other device associated with the communication system 100) may send a message, to a second communication device, via a plurality of communication protocols. For example, the first communication device may use (or may cause usage of) a plurality of communication protocols to transmit multiple copies of a same message to the second communication device. The second communication device may receive a copy of the message via at least one communication protocol of the plurality of communication protocols. The message may comprise an associated index number (e.g., as described with reference to FIG. 3). In an example, the first communication device may be the wireless hub 105 and the second communication device may be a wireless device 130.

At step 460, the first communication device may receive, via the at least one communication protocol, one or more respective acknowledgment message(s) (e.g., confirming successful reception/decoding of the message). For example, the first communication device may receive an acknowledgment message, via a communication protocol, if required (e.g., indicated) by the message and/or if the communication protocol requires acknowledgment message transmission.

The acknowledgement message may comprise a same index number as included in the message. In an example scenario wherein the first communication device sends the message via at least two communication protocols of the plurality of communication protocols, the second communication device may send acknowledgment messages via each of the at least two communication protocols. Alternatively, the second communication device may send an acknowledgment message via a selected communication protocol of the at least two communication protocol. The selected communication protocol may correspond to a communication protocol utilizing fewer channel resources and/or having a higher channel availability. Sending an acknowledgment message via only one communication protocol (e.g., even if the message has been successfully received via two or more communication protocols) may reduce signaling overhead.

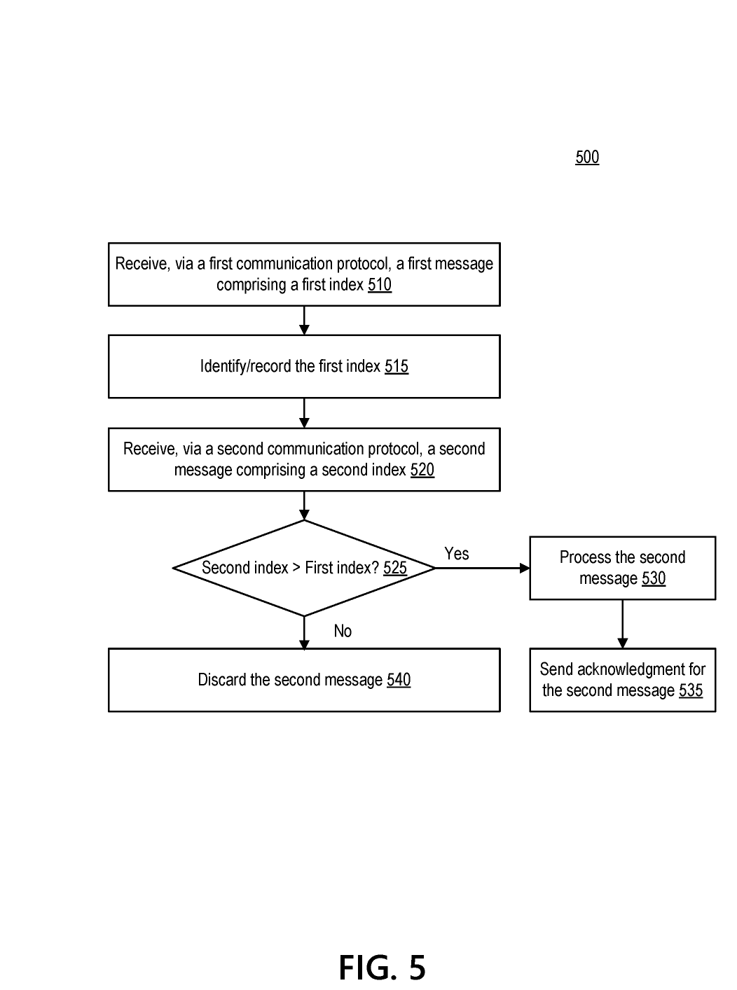

FIG. 5 shows an example method 500 for receiving a message. The example method 500 may be performed by the wireless hub 105, the APs 125, the wireless devices 130, and/or any other device associated with the communication system 100.

At step 510, a first communication device (e.g., the wireless hub 105, an AP 125, a wireless device 130, and/or any other device associated with the communication system 100) may receive a first message, from a second communication device, via a first communication protocol of a plurality of communication protocols. The message may comprise a first index value. At step 515, the first communication device may identify/record the first index value. For example, the first communication device may store the first index value in memory. The first communication device may store, decode, and/or forward (e.g., to an application and/or other devices) the first message. The first communication device may further send one or more acknowledgment messages corresponding to the first message (e.g., as described with respect to FIGS. 3, 4A and 4B). For example, the first communication device may send the one or more acknowledgment messages if required (e.g., indicated) by the first message and/or if the first communication protocol used for the first message requires acknowledgment message transmission.

In some examples, the first communication device may receive one or more repetitions of the first message via the first communication protocol. For example, the second communication device may retransmit the first message if the second communication device is unable to receive an acknowledgment message for the first message and/or if the acknowledgment message is dropped. The first communication device may send acknowledgment messages for each of the one or more repetitions of the first message.

At step 520, the first communication device may receive a second message, from the second communication device, via a second communication protocol of the plurality of communication protocols. The first communication device may receive the second message simultaneously or substantially simultaneously with the first message. The first communication device may receive the second message in a time period following the reception of the first message. The second message may comprise a second index value.

At step 525, the first communication device may determine whether the second index value is greater than the first index value. At step 530, and if the second index value is greater than the first index value, the first communication device may process the second message. Different index values in the first message and the second message may be considered as an indication of different payloads/data in the first message and the second message. The first communication device may store, decode, and/or forward (e.g., to an application and/or other devices) the second message. At step 535, the first communication device may further send an acknowledgment message for the second message (e.g., as described with respect to FIGS. 3 and 4).

At step 540, and if the second index value is less than or equal to the first index value, the first communication device may discard the second message. Same index values in the first message and the second message may be considered as an indication of same payloads/data in the first message and the second message. As such, and because the first message has already been received and/or processed, the second message may be considered as comprising “stale” information that need not be processed. Similarly, the second index value being less than the first index value may be considered as an indication that the second message comprises “stale” information (e.g., that is outdated or no longer valid). The first communication device may further refrain from sending an acknowledgment message for the second message.

A first communication device may perform a method comprising multiple operations. The first communication device may cause sending, to a second communication device via a plurality of communication protocols, a message. The message may comprise a first index. The first communication device may receive, from the second communication device via at least one of the plurality of communication protocols, an acknowledgement message. The acknowledgment message may comprise a second index. Based on a comparison of the first index of the message and the second index of the acknowledgment message, the first communication device may perform one or more operations. The first communication device may determine whether the second index of the acknowledgment message is equal to the first index of the message. The first communication device may, based on determining that the second index of the acknowledgment message is equal to the first index of the message, cause sending of a next message, stored in a buffer, via the plurality of communication protocols. The first communication device may, based on determining that the second index of the acknowledgment message is equal to the first index of the message, cause ceasing any further retransmissions of the message via all of the plurality of communication protocols. The first communication device may, based on determining that the second index of the acknowledgment message is equal to the first index of the message, send one or more indications to stop retransmissions of the message via all of the plurality of communication protocols. The first communication device may, based on determining that the second index of the acknowledgment message is not equal to the first index of the message cause resending, to the second communication device via the plurality of communication protocols, the message. The first communication device or the second communication device may be a wireless hub, an access point (AP), or a wireless device. The plurality of communication protocols may comprise one or more of: a Bluetooth protocol, a Zigbee protocol, an Institution of Electrical and Electronics Engineers (IEEE) 802.11 Wi-Fi protocol, an 802.11 Wi-Fi protocol, or a 3^{rd} Generation Partnership Project (3GPP) cellular protocol. The plurality of communication protocols may be associated with one or more of industrial, scientific, and medical (ISM) bands, a very high frequency (VHF) band, or an ultra-high frequency (UHF) band. The ISM bands may comprise one or more of: a 2.4 GHz-2.5 GHz band, a 5.75 GHz-5.875 GHz band, a 24 GHz-24.25 GHz band, or a 61 GHz-61.5 GHz band. The second communication device may comprise a wireless microphone, a bodypack, or an in-ear monitoring (IEM) system. The message may comprise audio data. The causing sending the message to the second communication device may comprise sending the message to a plurality of access points (APs) for transmission to the second communication device. The causing sending the message via a plurality of communication protocols may comprise sending a respective copy of the message via each of the plurality of communication protocols. The first communication device may comprise one or more processors; and memory storing instructions that, when executed by the one or more processors, cause the first communication device to perform the described method, additional operations and/or include the additional elements. A system may comprise the first communication device comprising one or more processors configured to perform the described method, additional operations and/or include the additional elements; and the second communication device configured to send the acknowledgment message. A computer-readable medium may store instructions that, when executed, cause performance of the described method, additional operations and/or include the additional elements.

A communication device may perform a method comprising multiple operations. The communication device may receive, via a first communication protocol, a first message comprising a first index. The communication device may receive, via a second communication protocol, a second message comprising a second index. The second communication protocol may be different from the first communication protocol. The communication device may, based on determining that the second index is less than or equal to the first index: process the first message, and discard the second message. The processing the first message and discarding the second message may comprise sending an acknowledgment for the first message and not sending an acknowledgment for the second message. The receiving the second message may comprise receiving the second message after receiving the first message. The receiving the second message may comprise receiving the second message simultaneously or substantially simultaneously with receiving the first message. The communication device may receive, via the first communication protocol, a third message comprising a third index. The communication device may receive, via the second communication protocol, a fourth message comprising a fourth index. The second communication protocol may be different from the first communication protocol. Based on determining that the fourth index is greater than the third index, the communication device may process the third message and the fourth message. The processing the third message and the fourth message may comprise sending an acknowledgment for the third message and sending an acknowledgment for the fourth message. The communication device may be a wireless hub, an access point (AP), or a wireless device. The first communication protocol or the second communication protocol may comprise one of: a Bluetooth protocol, a Zigbee protocol, an Institution of Electrical and Electronics Engineers (IEEE) 802.11 Wi-Fi protocol, an 802.11 Wi-Fi protocol, or a 3^{rd} Generation Partnership Project (3GPP) cellular protocol. The first communication protocol or the second communication protocol may be associated with one or more of: industrial, scientific, and medical (ISM) bands, a very high frequency (VHF) band, or an ultra high frequency (UHF) band. The ISM bands may comprise one or more of: a 2.4 GHz-2.5 GHz band, a 5.75 GHz-5.875 GHz band, a 24 GHz-24.25 GHz band, or a 61 GHz-61.5 GHz band. The first message or the second message may comprise audio data. The communication device may comprise one or more processors; and memory storing instructions that, when executed by the one or more processors, cause the communication device to perform the described method, additional operations and/or include the additional elements. A system may comprise the communication device comprising one or more processors configured to perform the described method, additional operations and/or include the additional elements; and another communication device configured to send the first message. A computer-readable medium may store instructions that, when executed, cause performance of the described method, additional operations and/or include the additional elements.

A first communication device may perform a method comprising multiple operations. The first communication device may receive, from a second communication device via at least one communication protocol of a plurality of communication protocols, a message. The message may comprise an index. The first communication device may send, via the at least communication protocol, an acknowledgement message. The acknowledgment message may comprise the index. The first communication device may comprise one or more processors; and memory storing instructions that, when executed by the one or more processors, cause the first communication device to perform the described method, additional operations and/or include the additional elements. A system may comprise the first communication device comprising one or more processors configured to perform the described method, additional operations and/or include the additional elements; and a second communication device configured to send the message. A computer-readable medium may store instructions that, when executed, cause performance of the described method, additional operations and/or include the additional elements.

A system comprising a first communication device and a second communication device may perform multiple operations. The first communication device may cause sending, to a second communication device via a plurality of communication protocols, a message. The message may comprise a first index. The first communication device may receive, from the second communication device via at least one of the plurality of communication protocols, an acknowledgement message. The acknowledgment message may comprise a second index. The first communication device may, based on a comparison of the first index of the message and the second index of the acknowledgment message, perform one or more operations. The second communication device may receive, via a first communication protocol of the plurality of communication protocols, the message. The second communication device may receive, via a second communication protocol of the plurality of communication protocols, the message. The second communication device may, based on determining that an index in the message received via the first communication protocol is the same as an index in the message received via the second communication protocol, discard the message received via the second communication protocol. The second communication device may be configured to send the acknowledgment message via the first communication protocol. The acknowledgment message may be for acknowledging reception of the message via the first communication protocol. The second index in the acknowledgment message may be equal to the first index in the message. The first communication device may, based on determining that the second index of the acknowledgment message is equal to the first index of the message, perform at least one of: causing sending a next message, stored in a buffer, via the plurality of communication protocols; causing ceasing any further retransmissions of the message via all of the plurality of communication protocols; or sending one or more indications to stop retransmissions of the message via all of the plurality of communication protocols. The first communication device or the second communication device may be a wireless hub, an access point (AP), or a wireless device. The first communication device may comprise one or more processors; and memory storing instructions that, when executed by the one or more processors, cause the first communication device to perform the described method, additional operations and/or include the additional elements. The second communication device may comprise one or more processors; and memory storing instructions that, when executed by the one or more processors, cause the second communication device to perform the described method, additional operations and/or include the additional elements. A computer-readable medium may store instructions that, when executed (e.g., by the first communication device and/or the second communication device), cause performance of the described method, additional operations and/or include the additional elements.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A method comprising:
causing sending, by a first communication device to a second communication device via a plurality of communication protocols, a message, wherein the message comprises a first index;
receiving, from the second communication device via at least one of the plurality of communication protocols, an acknowledgement message, wherein the acknowledgment message comprises a second index; and
based on a comparison of the first index of the message and the second index of the acknowledgment message, performing one or more operations.

2. The method of claim 1, wherein the performing the one or more operations comprises, based on determining that the second index of the acknowledgment message is equal to the first index of the message, performing at least one of:
causing sending a next message, stored in a buffer, via the plurality of communication protocols,
causing ceasing any further retransmissions of the message via all of the plurality of communication protocols, or
sending one or more indications to stop retransmissions of the message via all of the plurality of communication protocols.

3. The method of claim 1, wherein the performing the one or more operations comprises, based on determining that the second index of the acknowledgment message is not equal to the first index of the message: causing resending, to the second communication device via the plurality of communication protocols, the message.

4. The method of claim 1, wherein the first communication device or the second communication device is a wireless hub, an access point (AP), or a wireless device.

5. The method of claim 1, wherein the plurality of communication protocols comprises one or more of: a Bluetooth protocol, a Zigbee protocol, an Institution of Electrical and Electronics Engineers (IEEE) 802.11 Wi-Fi protocol, an 802.11 Wi-Fi protocol, or a 3^{rd} Generation Partnership Project (3GPP) cellular protocol.

6. The method of claim 1, wherein the plurality of communication protocols is associated with one or more of: industrial, scientific, and medical (ISM) bands, a very high frequency (VHF) band, or an ultra-high frequency (UHF) band, wherein the ISM bands comprise one or more of: a 2.4 GHz-2.5 GHz band, a 5.75 GHz-5.875 GHz band, a 24 GHz-24.25 GHz band, or a 61 GHz-61.5 GHz band.

7. The method of claim 1, wherein the causing sending the message to the second communication device comprises sending the message to a plurality of access points (APs) for transmission to the second communication device.

8. The method of claim 1, wherein the causing sending the message via a plurality of communication protocols comprises sending a respective copy of the message via each of the plurality of communication protocols.

9. A method comprising:
receiving, at a communication device via a first communication protocol, a first message comprising a first index;
receiving, via a second communication protocol, a second message comprising a second index, wherein the second communication protocol is different from the first communication protocol; and
based on determining that the second index is less than or equal to the first index: processing the first message, and discarding the second message.

10. The method of claim 9, wherein the processing the first message and discarding the second message comprises:
sending an acknowledgment for the first message; and
not sending an acknowledgment for the second message.

11. The method of claim 9, wherein the receiving the second message comprises receiving the second message after receiving the first message.

12. The method of claim 9, wherein the receiving the second message comprises receiving the second message simultaneously or substantially simultaneously with receiving the first message.

13. The method of claim 9, further comprising:
receiving, via the first communication protocol, a third message comprising a third index;
receiving, via the second communication protocol, a fourth message comprising a fourth index, wherein the second communication protocol is different from the first communication protocol; and
based on determining that the fourth index is greater than the third index, processing the third message and the fourth message.

14. The method of claim 13, wherein the processing the third message and the fourth message comprises sending an acknowledgment for the third message and sending an acknowledgment for the fourth message.

15. The method of claim 9, wherein the communication device is a wireless hub, an access point (AP), or a wireless device.

16. The method of claim 9, wherein the first message or the second message comprises audio data.

17. A system comprising:
a first communication device; and
a second communication device,
wherein the first communication device is configured to:
cause sending, to a second communication device via a plurality of communication protocols, a message, wherein the message comprises a first index;
receive, from the second communication device via at least one of the plurality of communication protocols, an acknowledgement message, wherein the acknowledgment message comprises a second index; and
based on a comparison of the first index of the message and the second index of the acknowledgment message, perform one or more operations, and
wherein the second communication device is configured to:
receive, via a first communication protocol of the plurality of communication protocols, the message;
receiving, via a second communication protocol of the plurality of communication protocols, the message; and
based on determining that an index in the message received via the first communication protocol is the same as an index in the message received via the second communication protocol, discard the message received via the second communication protocol.

18. The system of claim 17, wherein the second communication device is configured to send the acknowledgment message via the first communication protocol, wherein the acknowledgment message is for acknowledging reception of the message via the first communication protocol, and wherein the second index is equal to the first index.

19. The system of claim 17, wherein the first communication device being configured to perform the one or more operations comprises the first communication device being configured to, based on determining that the second index of the acknowledgment message is equal to the first index of the message, performing at least one of:
causing sending a next message, stored in a buffer, via the plurality of communication protocols,
causing ceasing any further retransmissions of the message via all of the plurality of communication protocols, or
sending one or more indications to stop retransmissions of the message via all of the plurality of communication protocols.

20. The system of claim 17, wherein the first communication device or the second communication device is a wireless hub, an access point (AP), or a wireless device.
